(19) United States
(12) Patent Application Publication
(10) Pub. No.: US 2005/0214710 A1
(43) Pub. Date: Sep. 29, 2005

(54) Method of providing a proportionally symmetrical gap-free smile

(76) Inventor: Craig M. Erskine-Smith, Balgowlah Heights (AU)

Correspondence Address: CONNOLLY BOVE LODGE & HUTZ LLP, SUITE 800, 1990 M STREET NW, WASHINGTON, DC, 20036-3425, US

(21) Appl. No.: 11/061,555

(22) Filed: Feb. 18, 2005

(30) Foreign Application Priority Data
Feb. 19, 2004 (AU) 2004 900 841

(51) Int. Cl. A61C 3/00

(52) U.S. Cl. 433/24

(57) ABSTRACT

A method of providing a symmetrically proportional gap-free smile including a computer product for carrying out the method. A method requires measurements of the lateral arch length, the lateral width of each tooth from the upper left canine to the upper right canine, and the lateral width of any gaps between the measured teeth. A proportional lateral width of each tooth in the measured lateral arch is calculated so that the lateral incisor widths are equal to 61% to 90% of the width of the central incisor, and the canine widths are equal to 80% to 99% of the width of the central incisor. The lateral width of the teeth in the measured lateral arch is modified to provide the calculated proportional tooth lateral widths extending along the measured lateral arch length without gaps between the teeth.

### FIELD OF THE INVENTION

The invention relates to cosmetic dentistry and, in particular, to a method of providing a symmetrically proportional gap-free smile in a person.

The invention has been developed primarily for use in providing a symmetrically proportional gap-free smile in exposed upper teeth and will be described hereinafter with reference to this particular application. However, there will be appreciated that the invention is not limited to this particular field of use.

### BACKGROUND ART

It is generally accepted that when a person smiles, that smile will comprise a plurality of upper teeth which are displayed more prominently than the lower teeth. Generally speaking, the teeth most exposed when a person smiles extend from the upper left canine or the first pre-molar around the top jaw arch to the contralateral tooth.

As such, observers of a smiling person will generally see the more prominently exposed upper teeth. If any contralateral teeth are of a substantially different lateral width or there are major gaps between the teeth, the smile of the person can look aesthetically unpleasant. Put in other words, if the lateral width of the upper teeth differ from their contralateral teeth, or if the teeth are in the wrong position about the arch, a less than ideal aesthetic result will be observable in the smile.

It is known for dentists in general practice to build up or shave off parts of upper teeth and to fill spaces and to proportion them with respect to their contralateral teeth according to various ratios such as the ‘divine’ or ‘golden’ proportion. However, the dentist or orthodontist does not generally move the teeth laterally about the upper arch centreline with anything other than a ‘gut-feel’ or hunch as to what positions to place the teeth to provide an aesthetically pleasant smile. Typically, the teeth are positioned such that any mesial or distal extensions required to achieve an aesthetically pleasing smile are placed equally on either side of the tooth rather than being placed on one side of the tooth surface when necessary.

Unilateral additions to teeth look lopsided and create the appearance of black or darkened triangles when the additions are extensive. Further, unilateral additions also create plaque traps and potential periodontal problems.

This situation is unfortunate as dentists in general practice are increasingly providing services to patients for aesthetic purposes rather than in response to specific problems such as toothaches. Resultantly, dentists are attempting to provide patients with smiles that are as aesthetically pleasing as possible. Disadvantageously, this is principally evident in inconsistent or unreproducible results for a symmetrically proportional gap-free smile between different patients.

### OBJECT OF THE INVENTION

It is an object of the present invention to provide a method of providing a symmetrically proportional gap-free smile which overcomes or substantially ameliorates one or more of the deficiencies of the prior art, or to provide a useful alternative.

### SUMMARY OF THE INVENTION

According to a first aspect of the invention there is provided a method of providing a symmetrically proportional gap-free smile in a person, the method including the steps of:
measuring a lateral arch length from the mesial of the of the upper left first pre-molar to the mesial of the contralateral tooth;
measuring the lateral width of each tooth from the upper left canine to the upper right canine;
measuring the lateral width of any gaps between the measured teeth;
calculating a proportional lateral width of each tooth in the measured lateral arch such that the lateral incisor widths are equal to 61% to 90% of the width of the central incisor and the canine widths are equal to 80% to 99% of the width of the central incisor; and
removing material from or adding material to the lateral width of the teeth in the measured lateral arch to provide the calculated proportional tooth lateral widths extending along the measured lateral arch length without gaps between the teeth.

In preferred embodiments of the invention, the method includes the steps of:
measuring the lateral arch length from the mesial of the upper left second pre-molar to the mesial of the contralateral tooth;
measuring any lateral gap between the teeth in the measured arch length;
calculating a proportional lateral tooth width for the first pre-molars in the measured lateral arch such that the first pre-molar lateral width is 76% to 82% of the width of the central incisor; end
removing material from or adding material to the lateral width of the first pre-molars, canines, lateral incisors and/or central incisors to provide the calculated lateral tooth widths without gaps between the teeth.

Preferably, the method includes the steps of:
moving the lateral position of one or more teeth along the measured lateral arch; and
removing material from the lateral widths of the teeth to allow the movement.

In preferred embodiments, the final lateral width of a tooth in the measured arch is the same is the lateral width of the contralateral tooth.

Preferably, the method includes the step of calculating the lateral extension length to be added to each lateral side of a tooth to provide symmetrical extensions to each individual tooth in the measured arch so as to provide the calculated lateral proportional gap-free tooth widths.

According to another aspect of the invention there is provided a computer program product including a computer usable medium having a computer readable program embodied therein for executing the steps of:
receiving data indicative of measured lateral arch length of teeth from the mesial of the upper left first pre-molar to the mesial of the contralateral tooth;
receiving data indicative of measured lateral widths of each tooth from the upper left canine to the upper right canine;
receiving data indicative of measured gaps between the teeth in the measured lateral arch; and
calculating a proportional lateral width of each tooth in the measured lateral arch such that the lateral incisor widths are equal to 61% to 90% of the width of the central incisor and the canine widths are equal to 80% to 99% of the width of the central incisor; and
providing a data output indicative of an amount of material to be removed from or added to the lateral width of the teeth in the measured lateral arch to provide a proportionally symmetric gap-free smile wherein the calculated proportional lateral tooth widths extend along the measured lateral arch length without gaps therebetween.

In preferred embodiments, the computer program product executes the step of providing a data output indicative of required lateral movement along the measured arch of one or more teeth therealong, and providing a data output indicative of the amount of material to be removed from the lateral width of the teeth to allow the movement.

It can therefore be seen that there is provided a method of reproducibly providing a symmetrically proportional gap-free smile in a person. There is also provided a computer program product including a computer usable medium having a computer readable program embodied therein for executing the steps of the method.

### BRIEF DESCRIPTION OF THE DRAWINGS

Preferred embodiments of the invention will now be described, by way of example only, with reference to the accompanying drawings in which:

FIG. 1 is a computer screen representation of a computer program product implementing a method according to a first embodiment; and

FIG. 2 is a computer screen representation of the computer program product implementing and method according to another embodiment.

### DETAILED DESCRIPTION

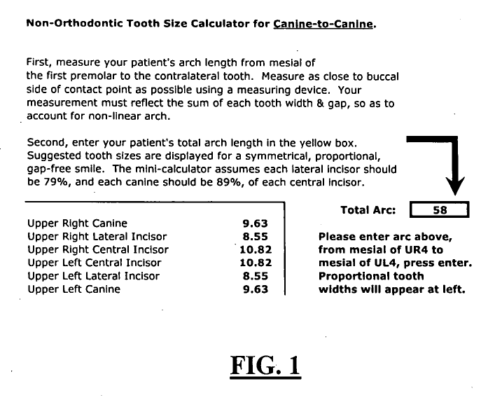

Turning to FIG. 1, there is shown a computer screen representation of the computer program product implementing a method of providing a symmetrically proportional gap-free smile in a person according to a first embodiment. The method includes the step of measuring the lateral arch length from the mesial of the upper left second pre-molar to the mesial of the contralateral tooth. This is shown as the “Total Arc 58” as measured in millimetres.

Although described below in respect of measured lateral arches extending from the mesial of the upper left second pre-molar to the mesial of the contralateral tooth, the arch length can likewise be measured from the mesial of the upper left first pre-molar to the mesial of the contralateral tooth. Similarly, the arch length can be measured from the mesial of the upper left canine to the mesial of the contralateral tooth or from the mesial of the upper left first molar to the mesial of the contralateral tooth.

The arch length can be directly measured by means of the length of tape or floss extending over the arch, however, this is not as desirable as measuring the arch length as the sum of the lateral teeth widths plus any gaps therebetween. This is because when individual teeth positions are plotted, a prescription for their ideal positioning to provide a symmetrically proportional gap-free smile can be obtained.

The embodiment of FIG. 1 shows the measured lateral arch length from the mesial of the upper left first pre-molar to the mesial of the contralateral tooth is 58 mm. However, it will be appreciated that each person can have different arch lengths. Similarly, to achieve reproducible results, the computer implemented product of affecting the method calculates the output shown in FIG. 1 and can be adapted to provide any predetermined preferred lateral tooth proportions.

Once the total lateral arch length is calculated, the preferred lateral widths of the teeth in the arch are calculated by the computer implemented product so as to provide a symmetrically proportional gap-free smile in the person. These are shown in the bottom left-hand corner of FIG. 1 and are determined as follows.

The lateral incisor width is calculated to be equal to 79% of the width of the central incisor, and the canine lateral widths are calculated to be equal to 89% of the width of the central incisor. In the preferred embodiments, the lateral width of the tooth is the same as that of its contralateral tooth.

The calculated lateral incisor widths can be in the range of 61% to 90% of the central incisor widths and the calculated lateral canine widths can be in the range of 80% to 99% of the width of the central incisors. These ranges are selected to depend on the preference of the patient or practitioner and on the desire to have teeth conforming to the proportions in published articles showing natural human tooth proportions, or the conforming to the ‘golden proportion’ of central incisor to lateral incisor width of 1:0.618, or other clinically relevant ratio.

The following equation is employed to determine a preferred central incisor lateral width (X) based on the measured arch:
lateral arch length=2[X+0.79X+0.89X]
where X is the lateral width of the central incisor. When this equation is solved for X the arch length=5.36X.

In this way, a proportionally symmetrical and gap-free smile can be provided to a person based on the measured lateral arch length. The arch length is calculated from the sum of the lateral to widths in the measured arch in question plus any gaps between the teeth.

Tooth material is then removed from, or added to, the lateral width of the teeth, in the measured arch length to provide lateral widths is calculated by the equation above so that no gaps exist between the teeth. If the amount of material to be removed from, or added to, the teeth appears to be clinically significant and/or detrimental to the health of the tooth/gum, the teeth can be laterally moved to a more ideal position. Lateral tooth extensions can then be made in composite, as pure extensions or as full labial coverage veneers, as porcelain veneers or chips, or as a full crown of any material.

In cases where the measured lateral arch length extends from the mesial of the upper left second pre-molar to the mesial of the contralateral tooth, the step of calculating a proportional lateral width to the first pre-molar is provided such that the lateral width of this tooth is 79% the width of the central incisor. In other embodiments of the invention, not illustrated, the formula above becomes the following:
lateral arch length=2[X+0.79X+0.89X+0.79X]
again in where X is the lateral width of the central incisors. Solving for this width, the preferred central incisor lateral width is the measured lateral arch length divided by 6.94.

It will be appreciated that the calculated proportional lateral width of the upper left first pre-molar and contralateral tooth can be between 76% to 82% of the width of the central incisor. The contralateral first pre-molar is preferably the same width, however, clinical experience may require some variation.

The method of the computer implemented program having a screen output shown in FIG. 1 can be generalised to calculate the lateral width of the second pre-molar as 77% the width of the central incisor when measuring from the mesial of the first molar to the mesial of the contralateral tooth.

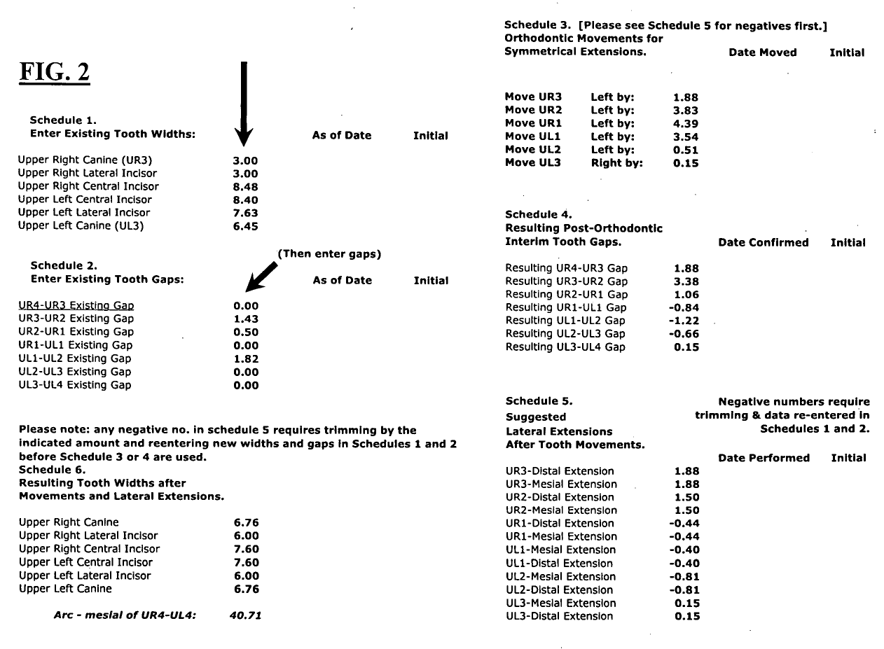

Referring now to FIG. 2, there is shown a computer screen representation of a computer implemented program effecting a method of providing a symmetrically proportional gap-free smile according to a second embodiment. In this embodiment, orthodontic movement of one or more teeth in a measured lateral arch length is provided, together with orthodontic movement of all the teeth in the measured arch about the dental midline of the person so that there is provided calculated teeth widths where the contralateral tooth width is the same and equidistantly spaced from the dental midline. It is noted that the dental midline of the person is defined as the point equidistant from the most distal tooth being used to the calculation, for example, the first pre-molar and the contralateral tooth.

The lateral width of each tooth in millimetres in the measured arch length is entered into Schedule 1 in any gaps between the teeth in millimetres are measured and entered into Schedule 2. The lateral arch length from the mesial of the upper left first pre-molar to the contralateral tooth is provided as the sum of the lateral teeth widths plus any measured gaps. This is denoted arch-mesial of UR4 to UL4. In this embodiment, the measured arch is 40.71 mm and it can be seen that the method of either FIG. 1 or 2 provides the accurate measurement of the lateral arch length with the patient's teeth in-situ.

Schedule 3 of FIG. 2 shows a computer screen representation of the amount each tooth in the measured lateral arch needs to be moved in millimetres to provide symmetrical gap-free extensions and to position the tooth ideally as afforded by the above equations.

Schedule 4 shows a calculation from resulting gaps between the teeth in the measured lateral arch length after tooth movement. It is noted that negative numbers indicate the presence of lateral material that needs to be removed from the lateral width of the tooth so as to create ideal lateral tooth widths.

Schedule 5 shows required lateral extensions after orthodontic movement of the teeth in the measured arch. Negative numbers indicate that tooth material should be removed from the lateral width of the tooth by the amount stipulated in the Schedule. The tooth widths and adjacent gaps after movement are then re-entered into the computer program to yield the correct schedules.

Schedule 6 provides the calculated proportional lateral tooth widths to provide the symmetrically proportional gap-free smile being disposed about the dental midline of a person. This is the finished result of laterally widening or stripping the teeth in the analysis, and this embodiment is based on the central incisor to lateral incisor to canine lateral ratio of 1:0.79:0.89. Although calculated in the same manner as in the method described with reference to FIG. 1, the embodiment described with reference to FIG. 2 also includes orthodontic movement of teeth to obtain the symmetrically proportional and gap-free smile together with interim tooth gaps provided at the end of the tooth movement phase.

That is, stripping or re-sizing of the lateral width of the teeth according to Schedule 5 (only where necessary as is often the case when canines substitute for missing the lateral incisors), then re-entering measurements into Schedules 1 and 2, then moving the teeth in the measured arch by the amounts shown in Schedule 3 with the lateral extensions shown in Schedule 5 will result in calculated lateral widths shown in Schedule 6.

In cases where there is a missing tooth, for example, a missing upper lateral incisor where the adjacent canine has drifted toward the missing tooth so as to effectively substitute for it, the width of the actual canine tooth is re-entered under the “existing the lateral incisor” in Schedule 1. This is because as the canine will become the lateral incisor and be 79% the width of the central incisor, and an implant or prosthetic canine will be provided with the lateral width of 89% of the width of the central incisor, or the first pre-molar converted to look like canine.

It is noted that the interim tooth gaps provided in Schedule 4 are related to the suggested lateral extensions after orthodontic movement shown in Schedule 5 such that the resulting UR4 to UR3 gap is equivalent to the UR3 distal extension, and UR3 to UR2 gap is equal to the sum of the UR3 mesial extension and UR2 distal extension.

As noted in respect of the method of either FIG. 1 or 2, non-orthodontic orthodontic movements can be used for measured lateral arch lengths extending from the mesial of the upper left second pre-molar to the contralateral tooth, or from the mesial of the upper left first molar to the contralateral tooth. In these embodiments, the equation above is amended to include a further component being twice the width of the second pre-molar and/or first molar wherein the second pre-molar is calculated to have a lateral width of 77% the lateral width of the central incisors and the first molar is calculated to have a lateral width of 117% of the lateral width of the central incisors. In such cases, the preferred central incisor size is determined from the measured arch length becomes the arch length divided by 8.48 and the arch length divided by 10.82 respectively. The calculated widths of the second pre-molar and the first molar can be in the range of 74% to 80% and 114% to 120% of the width of the central incisors respectively.

It can be seen that orthodontic movement of one or more teeth in the measured lateral arch length will not always been necessary. However, in situations where the teeth and the contralateral teeth are not equidistantly spaced about the dental midline or one or more teeth of drifted or teeth are missing and require prosthetics, orthodontic movement may be necessary and the method described with reference to FIG. 2 is applicable.

In cases where porcelain veneers are to be laterally added to one or more of the teeth in the measured arch, the lateral widths added to the teeth by the veneers must be compensated for. That is, lateral tooth enamel to be removed to facilitate the adhering of the veneers must be offset against the moving and/or trimming of lateral teeth widths of teeth in the arch. Importantly, the figure specified in Schedule 6 is the final tooth width and any restorative material thickness comes off this number.

Although described with reference to the upper teeth, the method of providing a symmetrically proportional smile in a person described with reference to the figures can be used the same way for providing symmetrically proportional mandibular teeth. The methods are substantially identical to those described above, however, the equation to determine the ideal central incisor lateral widths is altered so that the lower lateral incisor width is 107% the lateral width of the lower central incisor and the lower canine width 118% of the width of the lower central incisor.

Similarly, the lower first pre-molar is calculated to be 105% of the lateral width of the lower central incisor and the lower second pre-molar is also calculated to be 105% the lateral width of the lower central incisors. Thus, the calculated width of the lower central incisor (Y) is provided by the equation:
Measured lower arch length=2[Y+1.07Y+1.18Y+1.05Y+1.05Y].
Solving for the lower central incisor width, Y=measured lower arch length divided by 10.7.

When measuring the lateral width of the teeth in the measured arch from the mesial of the upper first pre-molar to the contralateral tooth, a calliper type linear measuring instrument (not illustrated) or the suitable measurement instrument can be used. Given of the average angular segment between the lateral contact points of the upper central and lateral incisors is approximately 17° when providing the symmetrically proportional and gap-free smile, the calliper type instrument preferably has tips angled at 17° to provide a more accurate measurement. Thus, more accurate lateral tooth and gap measuring can be made by compensating for tooth angulation.

It is sometimes clinically expedient to allow for a small amount of asymmetry between the lateral incisors and/or canines and/or premolars and/or molars. Usually, however, the central incisors must match despite other teeth being slightly asymmetrical. Thus it is sometimes necessary to calculate an ideal ratio over just three teeth, for example, the central incisors and one lateral incisor. In this case, the above formula can be re-written as measured arch length, A=2X+Z where X is the central incisor lateral width, Z is the lateral incisor width and A includes any gaps from the distal extremities of the teeth in question. In the case where Z=0.79X, solving for X gives X=A/2.79.

The foregoing describes only three preferred embodiments of the present invention and modifications, obvious to those skilled in the art, can be made thereto without departing from the scope of the present invention.

1. A method of providing a symmetrically proportional gap-free smile in a person, the method including the steps of:
measuring a lateral arch length from the mesial of the of the upper left first pre-molar to the mesial of the contralateral tooth;
measuring the lateral width of each tooth from the upper left canine to the upper right canine;
measuring the lateral width of any gaps between the measured teeth;
calculating a proportional lateral width of each tooth in the measured lateral arch such that the lateral incisor widths are equal to 61% to 90% of the width of the central incisor and the canine widths are equal to 80% to 99% of the width of the central incisor; and
removing material from or adding material to the lateral width of the teeth in the measured lateral arch to provide the calculated proportional tooth lateral widths extending along the measured lateral arch length without gaps between the teeth.

2. The method according to claim 1 including the steps of:
measuring the lateral arch length from the mesial of the upper left second pre-molar to the mesial of the contralateral tooth;
measuring any lateral gap between the teeth in the measured arch length;
calculating a proportional lateral tooth width for the first pre-molars in the measured lateral arch such that the first pre-molar lateral width is 76% to 82% of the width of the central incisor; end
removing material from or adding material to the lateral width of the first pre-molars, canines, lateral incisors and/or central incisors to provide the calculated lateral tooth widths without gaps between the teeth.

3. The method according to claim 1 including the steps of:
moving the lateral position of one or more teeth along the measured lateral arch; and
removing material from the lateral widths of the teeth to allow the movement.

4. The method according to claim 1 wherein the final lateral width of a tooth in the measured arch is the same is the lateral width of the contralateral tooth.

5. The method according to claim 3 including the step of calculating the lateral extension length to be added to each lateral side of a tooth to provide symmetrical extensions to each individual tooth in the measured arch so as to provide the calculated lateral proportional gap-free tooth widths.

6. A computer program product including a computer usable medium having a computer readable program embodied therein for executing the steps of:
receiving data indicative of measured lateral arch length of teeth from the mesial of the upper left first pre-molar to the mesial of the contralateral tooth;
receiving data indicative of measured lateral widths of each tooth from the upper left canine to the upper right canine;
receiving data indicative of measured gaps between the teeth in the measured lateral arch; and
calculating a proportional lateral width of each tooth in the measured lateral arch such that the lateral incisor widths are equal to 61% to 90% of the width of the central incisor and the canine widths are equal to 80% to 99% of the width of the central incisor; and
providing a data output indicative of an amount of material to be removed from or added to the lateral width of the teeth in the measured lateral arch to provide a proportionally symmetric gap-free smile wherein the calculated proportional lateral tooth widths extend along the measured lateral arch length without gaps therebetween.

7. The computer program product according to claim 6 for executing the step of providing a data output indicative of required lateral movement along the measured arch of one or more teeth therealong, and providing a data output indicative of the amount of material to be removed from the lateral width of the teeth to allow the movement.
